(19) United States
(12) Patent Application Publication
(10) Pub. No.: US 2008/0256397 A1
(43) Pub. Date: Oct. 16, 2008

(54) System and Method for Network Performance Monitoring and Predictive Failure Analysis

(75) Inventor: Les Smith, Pleasanton, CA (US)

Correspondence Address: DICKSTEIN SHAPIRO LLP, 1825 EYE STREET NW, Washington, DC, 20006-5403, US

(73) Assignee: XYRATEX TECHNOLOGY LIMITED, Havant (GB)

(21) Appl. No.: 11/662,744

(22) PCT Filed: Sep. 22, 2005
(86) PCT No.: PCT/US05/34212

§ 371 Date: Jun. 20, 2007

Related U.S. Application Data
(60) Provisional application No. 60/611,805, filed on Sep. 22, 2004.

(51) Int. Cl. G06F 11/30

(52) U.S. Cl. 714/47; 714/E11.179

(57) ABSTRACT

A method and system for detecting performance degradation of a plurality of monitored components in a networked storage system. Performance data is collected from the plurality of monitored components. Component statistics are generated from the collected performance data. Heuristics are applied to the generated component statistics to determine the likelihood of failure or degradation of each of the plurality of monitored components.

### CROSS-REFERENCE TO RELATED APPLICATIONS

This application claims the benefit of U.S. Provisional Application Ser. No. 60/611,805, filed Sep. 22, 2004 in the U.S. Patent and Trademark Office, the entire content of which is incorporated by reference herein.

### FIELD OF THE INVENTION

The present invention relates to error detection and recovery and, more specifically, to a system and method for detecting degradation in the performance of a device, such as a component in a redundant arrays of inexpensive disks (RAID) network, before it fails to operate, thus providing for a means of device management such that the availability of the network is guaranteed.

### BACKGROUND OF THE INVENTION

RAID is currently the principle storage architecture for large networked computer storage systems. RAID architecture was first documented in 1987 when Patterson, Gibson and Katz published a paper entitled, “A Case for Redundant Arrays of Inexpensive Disks (RAID)” (University of California, Berkeley). Fundamentally, RAID architecture combines multiple small, inexpensive disk drives into an array of disk drives that yields performance that exceeds that of a Single Large Expensive Drive (SLED). Additionally, this array of drives appears to the computer as a single logical storage unit (LSU) or drive. Five types of array architectures, designated as RAID-1 through RAID-5, were defined by the Berkeley paper, each providing disk fault-tolerance and each offering different trade-offs in features and performance. In addition to these five redundant array architectures, a non-redundant array of disk drives is referred to as a RAID-0 array. RAID controllers provide data integrity through redundant data mechanisms, high speed through streamlined algorithms, and accessibility to the data for users and administrators.

The mean time between failures (MTBF) of an array of disk drives is approximately equal to the MTBF of an individual drive, divided by the number of drives in the array. As a result, the typical MTBF of an array of drives, such as RAID, would be too low for many applications. However, this shortcoming is overcome by making disk arrays fault-tolerant by incorporating both redundancy and some form of data interleaving, which distributes the data over all the disks in the array. Redundancy is usually accomplished with use of an error correcting code, combined with simple parity schemes. RAID-1, for example, uses a “mirroring” redundancy scheme, in which duplicate copies of the same data are stored on two separate disks in the array. Parity and other error correcting codes are either stored on one or more disks dedicated for that purpose only or are distributed over all the disks in the array. Data interleaving is usually in the form of data “striping,” in which the data to be stored is broken down into blocks called “stripe units,” which are then distributed across the data disks.

Individual stripe units are located on unique physical storage devices. Physical storage devices, such as disk drives, are often partitioned into two or more logical drives, which the operating system distinguishes as discrete storage devices. When a single physical storage device fails and stripe units of data cannot be read from that device, the data may be reconstructed through the use of the redundant stripe units of the remaining physical devices. In the case of a disk rebuild operation, this data is written to a new replacement device that is designated by the end user. Media errors that result in the device not being able to supply the requested data for a stripe unit on a physical drive can occur. If a media error occurs during a logical drive rebuild, the drive will be corrupted, the entire logical drive will go offline, and the data that belongs to that logical drive will be lost. To bring the logical drive back online, the user must replace the corrupted physical drive. However, for many applications, for example, banking and other financial applications, loss of data, or even temporary inaccessibility of data, is devastating. In addition, replacing damaged disk drives can be a lengthy task, and, potentially, can cause loss of network service for many hours. In many applications, this adds a further encumbrance; for example, world market financial data that is even a few hours old can have an adverse effect on investments.

Therefore, restoring mass-storage data in a RAID network is a time consuming and imperfect process. Furthermore, mass storage hardware is limited in its reliability and will inevitably fail. However, predictors of failure exist and precede catastrophic loss of data. What is needed is a method of detecting degradation in the performance of a device, such as a component in a RAID network, by monitoring these predictors and replacing components before failure. What is further needed is a way of predicting when such failures may occur and providing for a means of device management, such that the availability of the system is guaranteed.

An example of an invention for monitoring RAID networks and reporting and recovering data caused by defective media is found in U.S. Pat. No. 6,282,670, entitled, “Managing Defective Media in a RAID System.” The '670 patent describes a means of managing data while a RAID system is recovering from a media error. As a media error occurs, the failing storage device is identified, and the areas of failure are recorded in non-volatile storage. A data recovery process is then continued so that a maximum amount of data can be recovered, even though more than one error has occurred. Areas of failure are recorded in both non-volatile memory on the RAID adapter card and in reserved areas of remaining storage devices. The storage areas that have been detected to contain media errors are stripe number, stripe unit number, and down-to-the-sector-number granularity. When the user tries to access data, these records are checked. Although the user may lose a small portion of the data, the user is presented with an error message, instead of with incorrect data.

While the '670 patent provides a means of monitoring and reporting areas of failure within a RAID network and performing a data recovery process, the invention does not provide a means of predicting failures and, therefore, it can not ensure that all of the mass-storage data has been preserved prior to a disk failure.

It is therefore an object of the invention to provide a means of detecting degradation in the performance of a component in a mass-storage system, such as a RAID network, before it fails to operate.

It is another object of this invention to provide a way of predicting a time when a storage unit, such as a disk drive in a RAID network, will malfunction.

It is yet another object of this invention to provide a means of system management for mass storage system, such as a RAID network, such that the availability of mass-storage data is guaranteed.

### BRIEF SUMMARY OF THE INVENTION

The present invention provides a method for detecting performance degradation of a plurality of monitored components in a networked storage system. The method includes collecting performance data from the plurality of monitored components. Component statistics are generated from the collected performance data. Heuristics are applied to the generated component statistics to determine the likelihood of failure or degradation of each of the plurality of monitored components.

The present invention also provides a system for detecting performance degradation in a networked storage system. The system includes a plurality of monitored networked components. The system also includes a network controller. The network controller is configured to collect performance data from the plurality of monitored networked components. The network controller also generates component statistics from the collected performance data. Heuristics are applied to the generated component statistics to determine the likelihood of failure or degradation of each of the plurality of monitored networked components.

These and other aspects of the invention will be more clearly recognized from the following detailed description of the invention which is provided in connection with the accompanying drawings.

### BRIEF DESCRIPTION OF THE DRAWINGS

FIG. 1 illustrates a block diagram of a conventional RAID networked storage system in accordance with an embodiment of the invention.

FIG. 2 illustrates a block diagram of a RAID controller system in accordance with an embodiment of the invention.

FIG. 3 illustrates a block diagram of RAID controller hardware for use with an embodiment of the invention.

FIG. 4 illustrates a flow diagram of a method of monitoring a conventional RAID networked storage system in order to detect degradation and to predict component malfunction in communication means and to provide recovery without loss of data in accordance with an embodiment of the invention.

### DETAILED DESCRIPTION OF THE INVENTION

The present invention is a system and method for detecting degradation in the performance of a component in a RAID network before it fails to operate and to provide for a means of device management such that the availability of data is greatly improved. The method of the present invention includes the steps of accumulating performance data, applying heuristics, checking for critical errors, warnings and informational events, generating events, waiting for next time period, and deciding to perform pre-emptive error aversion within the system.

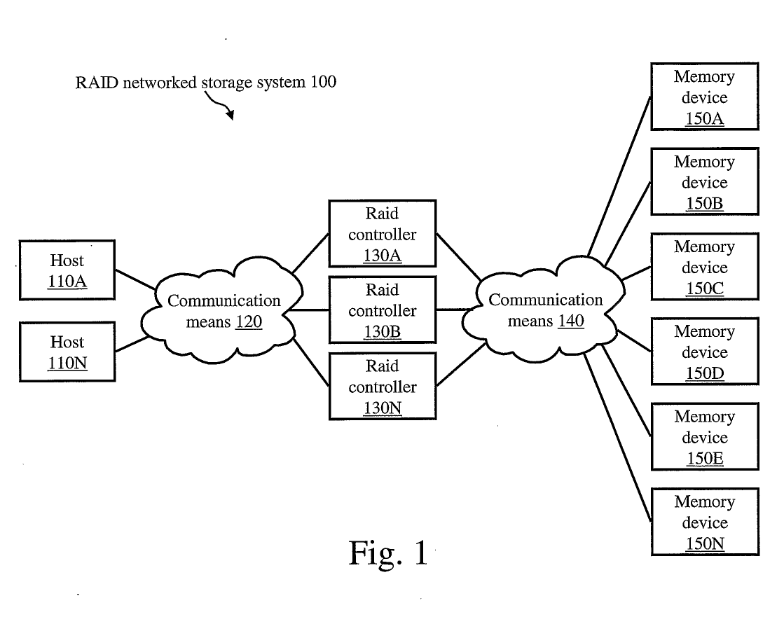

FIG. 1 is a block diagram of a conventional RAID networked storage system 100 that combines multiple small, inexpensive disk drives into an array of disk drives that yields superior performance characteristics, such as redundancy, flexibility, and economical storage. RAID networked storage system 100 includes a plurality of hosts 110A through 110N, where ‘N’ is not representative of any other value ‘N’ described herein. Hosts 110 are connected to a communications means 120, which is farther coupled via host ports (not shown) to a plurality of RAID controllers 130A and 130B through 130N, where ‘N’ is not representative of any other value ‘N’ described herein. RAID controllers 130 are connected through device ports (not shown) to a second communication means 140, which is further coupled to a plurality of memory devices 150A through 150N, where ‘N’ is not representative of any other value ‘N’ described herein. Memory devices 150 are housed within enclosures (not shown).

Hosts 110 are representative of any computer systems or terminals that are capable of communicating over a network. Communication means 120 is representative of any type of electronic network that uses a protocol, such as Ethernet. RAID controllers 130 are representative of any storage controller devices that process commands from hosts 110 and, based on those commands, control memory devices 150. RAID controllers 130 also provide data redundancy, based on system administrator programmed RAID levels. This includes data mirroring, parity generation, and/or data regeneration from parity after a device failure. Physical to logical and logical to physical mapping of data is also an important function of the controller that is related to the RAID level in use. Communication means 140 is any type of storage controller network, such as iSCSI or fibre channel. Memory devices 150 may be any type of storage device, such as, for example, tape drives, disk drives, non-volatile memory, or solid state devices. Although most RAID architectures use disk drives as the main storage devices, it should be clear to one skilled in the art that the invention embodiments described herein apply to any type of memory device.

In operation, host 110A, for example, generates a read or a write request for a specific volume, (e.g., volume 1), to which it has been assigned access rights. The request is sent through communication means 120 to the host ports of RAID controllers 130. The command is stored in local cache in, for example, RAID controller 130B, because RAID controller 130B is programmed to respond to any commands that request volume 1 access. RAID controller 130B processes the request from host 110A and determines the first physical memory device 150 address from which to read data or to which to write new data. If volume 1 is a RAID 5 volume and the command is a write request, RAID controller 130B generates new parity, stores the new parity to the parity memory device 150 via communication means 140, sends a “done” signal to host 110A via communication means 120, and writes the new host 110A data through communication means 140 to the corresponding memory devices 150.

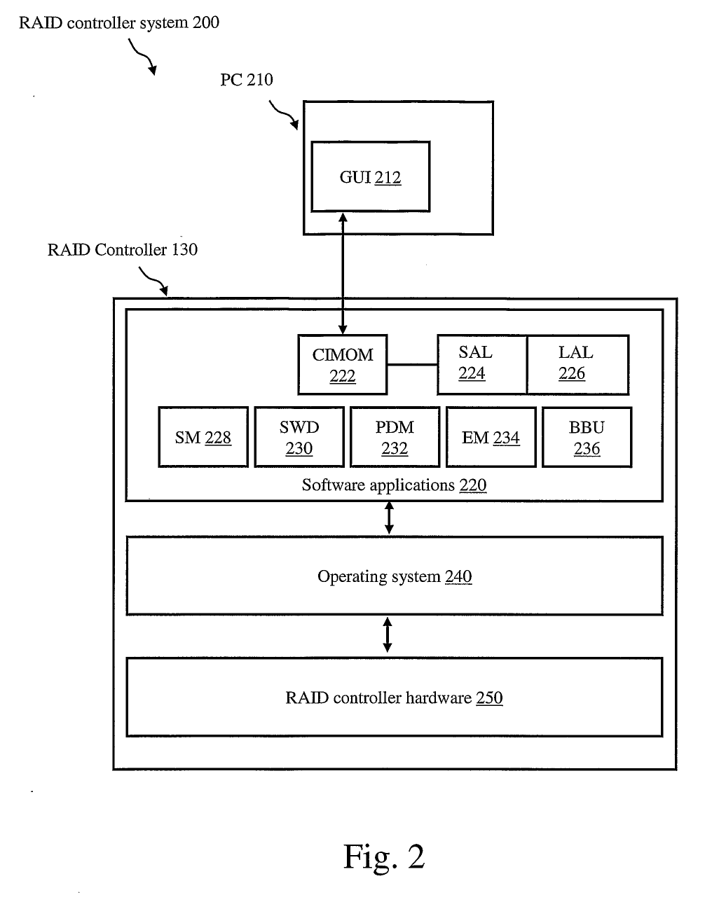

FIG. 2 is a block diagram of a RAID controller system 200. RAID controller system 200 includes RAID controllers 130 and a general purpose personal computer (PC) 210. PC 210 further includes a graphical user interface (GUI) 212. RAID controllers 130 further include software applications 220, an operating system 240, and a RAID controller hardware 250. Software applications 220 further include a common information module object manager (CIMOM) 222, a software application layer (SAL) 224, a logic library layer (LAL) 226, a system manager (SM) 228, a software watchdog (SWD) 230, a persistent data manager (PDM) 232, an event manager (EM) 234, and a battery backup (BBU) 236.

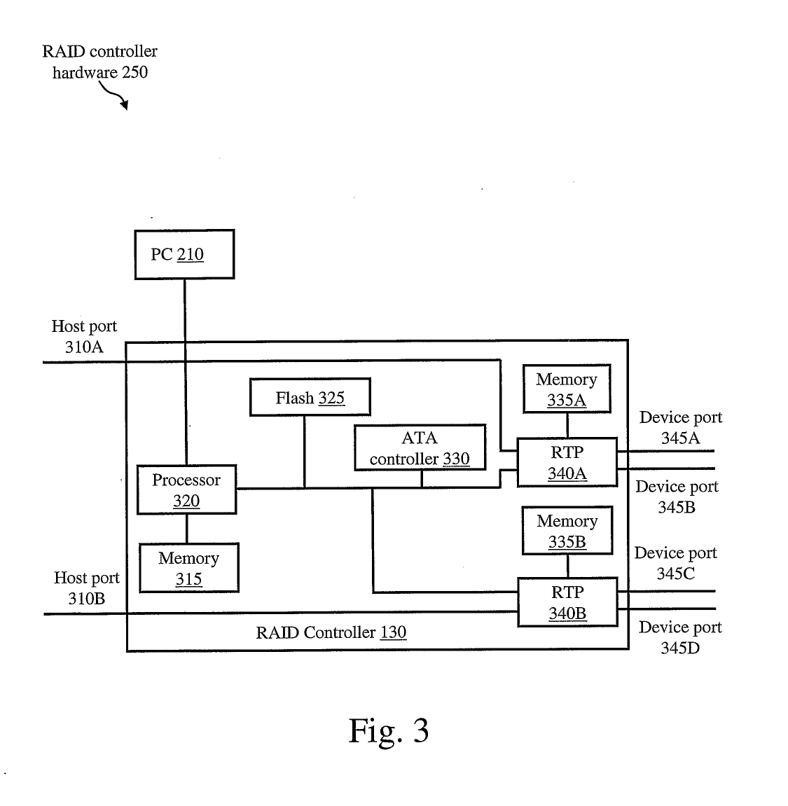

GUI 212 is a software application used to input personality attributes for RAID controllers 130 and to display the status of RAID controllers 130 and memory devices 150 during run-time. GUI 212 runs on PC 210. RAID controllers 130 are representative of RAID storage controller devices that process commands from hosts 110 and, based on those commands, control memory devices 150. As shown in FIG. 2, RAID controllers 130 are an exemplary embodiment of the invention; however, other implementations of controllers may be envisioned here by those skilled in the art. RAID controllers 130 provide data redundancy, based on system-administrator-programmed RAID levels. This includes data mirroring, parity generation, and/or data regeneration from parity after a device failure. RAID controller hardware 250 is the physical processor platform of RAID controllers 130 that executes all RAID controller software applications 220 and which consists of a microprocessor, memory, and all other electronic devices necessary for RAID control, as described in detail in the discussion of FIG. 3. Operating system 240 is an industry-standard software platform, such as Linux, for example, upon which software applications 220 runs. Operating system 240 delivers other benefits to RAID controllers 130. Operating system 240 contains utilities, such as a file system, which provide a way for RAID controllers 130 to store and transfer files. Software applications 220 contain the algorithms and logic necessary for RAID controllers 130 and are divided into those needed for initialization and those that operate at run-time. Software applications 220 consists of the following software functional blocks: CIMOM 222, which is a module that instantiates all objects in software applications 220 with the personality attributes entered, SAL 224, which is the application layer upon which the run-time modules execute, and LAL 226, a library of low-level hardware commands that are used by a RAID transaction processor, as described in the discussion of FIG. 3.

Software applications 220 that operate at run-time consists of the following software functional blocks: system manager 228, a module that carries out the run-time executive; SWD 230, a module that provides software supervision function for fault management; PDM 232, a module that handles the personality data within software applications 220; EM 234, a task scheduler that launches software applications 220 under conditional execution; and BBU 236, a module that handles power bus management for battery backup.

FIG. 3 is a block diagram of RAID controller hardware 250. RAID controller hardware 250 is the physical processor platform of RAID controllers 130 that executes all RAID controller software applications 220 and that consists of host ports 310A and 310B, memory 315, a processor 320, a flash 325, an ATA controller 330, memory 335A and 335B, RAID transaction processors (RTP) 340A and 340B, and device ports 345A through 345D.

Host ports 310 are the input for a host communication channel, such as an iSCSI or a fibre channel.

Processor 320 is a general purpose micro-processor, for example a Motorola 405xx, that executes software applications 220 that run under operating system 240.

PC 210 is a general purpose personal computer that is used to input personality attributes for RAID controllers 130 and to provide the status of RAID controllers 130 and memory devices 150 during run-time.

Memory 315 is volatile processor memory, such as synchronous DRAM.

Flash 325 is a physically removable, non-volatile storage means, such as an EEPROM. Flash 325 stores the personality attributes for RAID controllers 130.

ATA controller 330 provides low level disk controller protocol for Advanced Technology Attachment protocol memory devices.

RTP 340A and 340 B provide RAID controller functions on an integrated circuit and use memory 335A and 335B for cache.

Memory 335 A and 335B are volatile memory, such as synchronous DRAM.

Device ports 345 are memory storage communication channels, such as iSCSI or fibre channels.

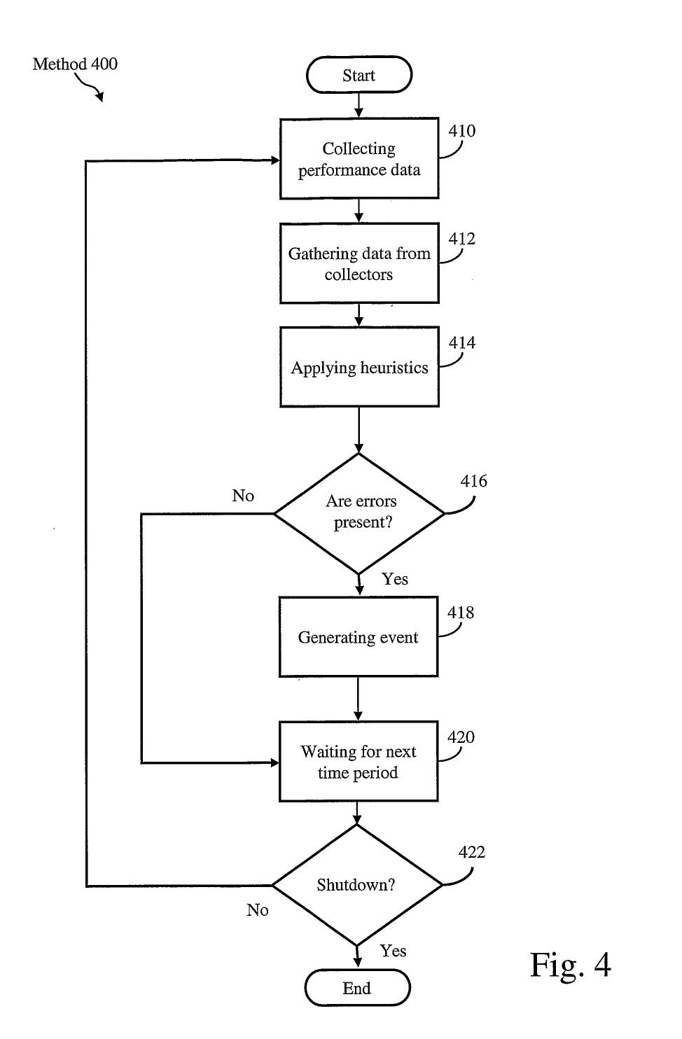

FIG. 4 illustrates a flow diagram of a method 400 of monitoring a conventional RAID networked storage system 100 in order to detect degradation and to predict component malfunction in communications means 120, RAID controllers 130, second communication means 140, or memory devices 150, and to provide recovery without loss of data. FIGS. 1 through 3 are referenced throughout the method steps of method 400. Further, it is noted method 400 is not limited to use with RAID controllers 130; method 400 may be used with any generalized controller system or application.

Method 400 includes the steps of:

### Step 410: Collecting Performance Data

In this step, SM 228 executes multiple sub-processes, called “collectors” (not shown). A collector is a background task that is employed by SM 228 in order to query the various components of raid controllers 130 and memory devices 150; for example, collectors perform a read operation to an Ethernet controller's status registers (not shown) and accumulate Ethernet status data. Method 400 proceeds to step 412.

Step 412: Gathering Data from Collectors

In this step, SM 228 gathers the disparate status data collected in step 410 and aggregates the pertinent data into data records that characterize system operational status. As a result, SM 228 accumulates statistics for the various components of raid controllers 130 and storage devices 150 that are measurements of their performance over a period of time. Method 400 proceeds to step 414.

### Step 414: Applying Heuristics

In this step, SM 228 applies heuristics to data records assembled in step 412 to determine the likelihood for failure or degradation of the components of RAID networked storage system 100 and develops a status level for each component, i.e., critical, informational, or normal. For example, a critical status level for storage devices 150 in a RAID networked storage system 100 indicates a trend of rapid deterioration and imminent failure. Method 400 proceeds to step 416.

### Step 416: Are Errors Present?

In this decision step, SM 228 determines whether any errors have occurred or are likely to occur in the near future, according to the heuristics of step 414. If errors are detected, a determination is made whether the errors are critical errors, errors that result in warnings, or errors that result in informational messages. If errors are present, method 400 proceeds to step 418. If errors are not present, method 400 proceeds to step 420.

### Step 418: Generating Event

In this step, an event is generated by RAID controllers 130 and sent to PC 210 via a standard PC interconnect, for example, Ethernet, to indicate that an error has occurred or is likely to occur as shown by a display on GUI 212. The event may be followed by a corrective action by a system administrator or by an automated recovery process (not shown) and by restoration of one or more components of RAID controllers 130, in accordance with the nature of the potential failure mechanism. For example, the system administrator may be warned of an impeding failure in storage devices 150, e.g., a disk drive, as indicated by a display on GUI 212. The disk drive can then be replaced, at a convenient time, prior to device failure. In the case of a disk drive rebuild operation; the data will be automatically reconstructed on the replacement disk drive by RAID controllers 130 by their use of the redundant stripe units of the remaining memory devices 150. Method 400 proceeds to step 420.

### Step 420: Waiting for Next Time Period

In this step, RAID controllers 130 wait for next time period. Method 400 proceeds to step 422.

### Step 422: Shut Down?

In this decision step, RAID controllers 130 test for the presence of a system power down command. If yes, method 400 ends, if no returns to step 410.

Although the present invention has been described in relation to particular embodiments thereof, many other variations and modifications and other uses will become apparent to those skilled in the art. Therefore, the present invention is to be limited not by the specific disclosure herein, but only by the appended claims.

What is claimed is:

1. A method for detecting performance degradation of a plurality of monitored components in a networked storage system, comprising:
collecting performance data from the plurality of monitored components;
generating component statistics from the collected performance data; and
applying heuristics to the generated component statistics to determine the likelihood of failure or degradation of each of the plurality of monitored components.

2. The method of claim 1, wherein the step of collecting performance data occurs continuously as a background operation by a software program on a network controller.

3. The method of claim 1, wherein the plurality of monitored components include a plurality of memory devices and a plurality of network controllers.

4. The method of claim 1, wherein the applied heuristics result in a reporting of a status level for each of the plurality of monitored components.

5. The method of claim 4, further comprising generating an error message when the status level of a component of the plurality of monitored components indicates that the component requires attention.

6. The method of claim 5, further comprising taking corrective action after generation of an error message.

7. A system for detecting performance degradation in a networked storage system, comprising:
a plurality of monitored networked components; and
a network controller configured to collect performance data from the plurality of monitored networked components, generate component statistics from the collected performance data, and apply heuristics to the generated component statistics to determine the likelihood of failure or degradation of each of the plurality of monitored networked components.

8. The system of claim 7, wherein the performance data is collected continuously as a background operation by a software program on the network controller.

9. The system of claim 7, wherein the plurality of monitored networked components include a plurality of memory devices and a plurality of network controllers.

10. The system of claim 7, wherein the applied heuristics result in a reported status level for each of the plurality of monitored networked components.

11. The system of claim 10, wherein the applied heuristics result in an error message when the status level of a component of the plurality of monitored networked components indicates that the component requires attention.

12. The system of claim 11, wherein the applied heuristics result in corrective actions after generation of an error message.
